(19) United States
(12) Patent Application Publication
(10) Pub. No.: US 2008/0084072 A1
(43) Pub. Date: Apr. 10, 2008

(54) Moving Coil Electrical Generators

(75) Inventors: Berj A. Terzian, Newbury, MA (US); Jack A. Ekchian, Belmont, MA (US)

Correspondence Address: LUCAS & MERCANTI, LLP, 475 PARK AVENUE SOUTH, 15TH FLOOR, NEW YORK, NY, 10016, US

(73) Assignee: INCELEX, LLC, Newbury, MA (US)

(21) Appl. No.: 11/612,346

(22) Filed: Dec. 18, 2006

Related U.S. Application Data
(60) Provisional application No. 60/828,087, filed on Oct. 4, 2006.

(51) Int. Cl. H02K 7/18; H02K 35/00; H02K 33/00

(52) U.S. Cl. 290/1 R; 310/36; 310/15

(57) ABSTRACT

A moving coil electrical generator includes a hollow passageway of predetermined configuration and length, at least one permanent magnet supported in a position which extends its magnetic flux through empty space within the passageway, at least one electrically conductive coil placed within and configured to physically move through the passageway, at least two separate pairs of contacts on the coil and the passageway which remain in substantial physical contact and electrical continuity with each other as the coil moves through the passageway, whereby electrical voltage and current are generated in the coil as it moves through and intersects the magnetic flux within the passageway. The generator can be isolated with metallic shielding to prevent or minimize outward magnetic leakage.

### BACKGROUND OF THE INVENTION

1. Field of the Invention

This invention relates to electrical generators which can be incorporated in electrically or electronically operated devices to render them capable of self generating electrical power when put into physical motion, without need for access to external electrical sources.

2. Drawbacks of Prior Systems

The present applicants are co-inventors of prior inventions described in earlier filed, co-pending applications which are identified by the following serial numbers and titles:

Ser. No. 11/191,890 Armature Type Electrical Generators for Self Powered Cellphones

Ser. No. 11/199,309 Enhanced Internal Electrical Generators

Ser. No. 11/328,661 Optimized Electrical Generators

The disclosures of these earlier applications are incorporated by reference herein.

These previous systems are based on motion of permanent magnets through or beside electrically conductive wire coils, which generates electrical voltage and current in the coils pursuant to the Faraday phenomenon of disruption of the flux of a magnetic field when a conductor is in relative motion to the field and intersects its flux lines.

The fact that the magnetic member is in physical motion in these systems poses a problem if it is desired to shield the system against magnetic leakage that could adversely affect adjacent electrical or electronic circuits, especially in small, closely packed devices such as cellphones, i-Pods, MP-3 players, and the like. Therefore, there is a need for modifying the prior systems to facilitate adoption of magnetic shielding and gaining other advantages that improve the efficacy of the systems.

### SUMMARY OF THE INVENTION

The present invention provides a solution to the above discussed problem and upgrades the efficacy and power output of the modified system. In particular, in the systems of the present invention, one or more conductive wire coils are put into physical motion through the magnetic flux of permanent magnets maintained in stationary positions, relative to a housing, beside or flanking the coils, thus enabling the addition of a magnetic shield around the magnets that minimizes or prevents leakage of magnetic flux to the surroundings. In addition, the moving conductive coils can be formed with successive ribbons or turns of coil and spaces having no coils, whereby repeated disruptions of magnetic flux and generation of electrical power pulses can be achieved as the coils move through the flux.

### BRIEF DESCRIPTION OF THE DRAWINGS

Further details of the present invention will be readily understood by reference to the follow drawings of which:

FIG. 1 is an exploded perspective view of a first embodiment of the invention.

FIG. 2 is a side view of a movable conductive wire coil.

FIG. 3 is a cross sectional view through the diameter of the coil of FIG. 2.

FIG. 4 is a modified view of FIG. 2 which includes a magnetic shield.

FIG. 5 is a perspective view of the movable wire coil of FIG. 2 with introduction of empty spaces.

### DETAILED DESCRIPTION OF THE INVENTION

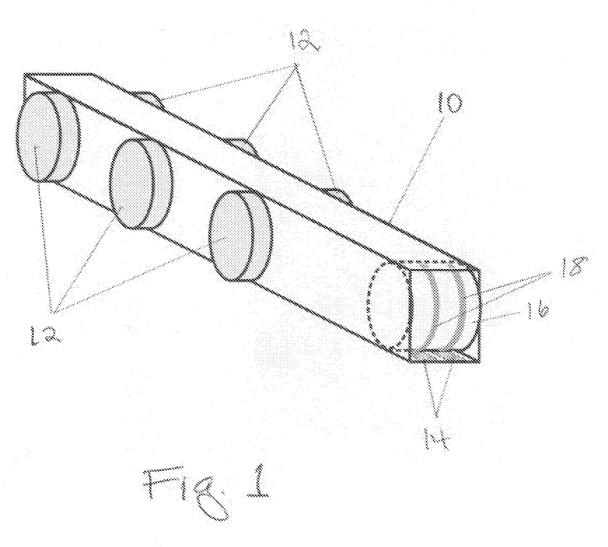

Referring to FIG. 1, it depicts a passageway 10 having a rectangular cross section, with the wider pair of walls oriented vertically to provide spaced sidewalls. Affixed to both sidewalls are a series of permanent magnets 12, each in sets of three successive magnets.

Passageway 10 is preferably made of electrically nonconductive material. The floor of the passageway includes two electrically conductive tracks 14 which are spaced apart from each other.

Within the interior of passageway 10 is a disc-shaped roller 16 preferably made of electrically non-conductive material. The circumferential edge of roller 16 is fitted with two electrically conductive rings 18 that are spaced apart to rest in contact with the tracks 14.

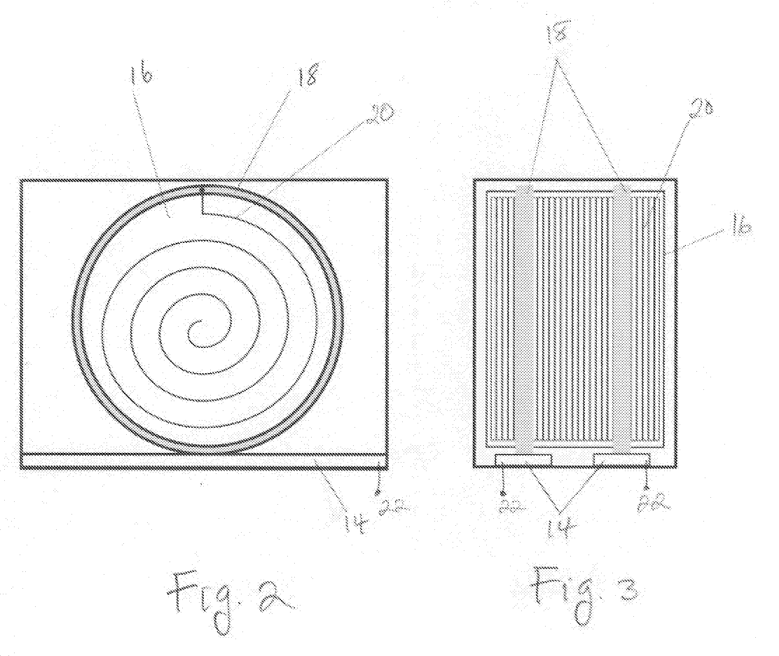

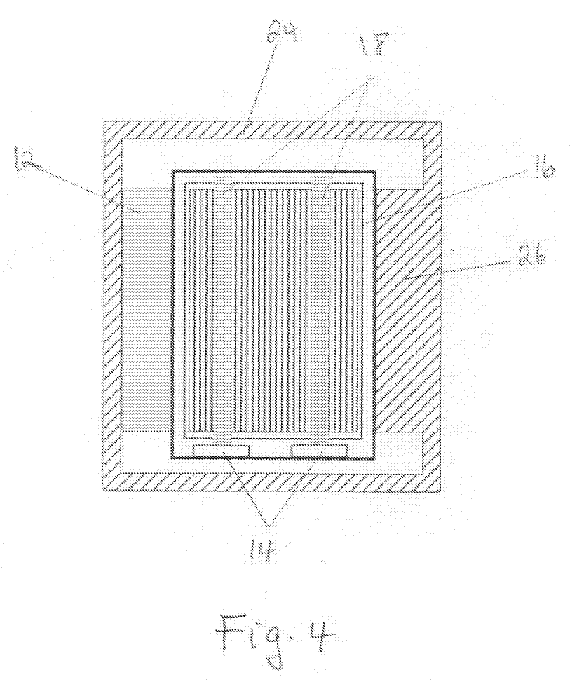

As shown in FIGS. 2 and 3, ring contacts 18 are also electrically in contact with multiple coils of magnet wire 20 wound around the circular edge of roller 16. The coils of magnet wire 20 are insulated from each other except for the areas in contact with the rings 18. Therefore, there is electrical continuity from the magnet wire 20 to the rings 18 and the tracks 14. Tracks 14 are connected to output terminals 22 that are, in turn, connected to leads that deliver current to operating circuits or electrical storage components such as rechargeable batteries or capacitors of cellphones, i-Pods, MP-3 players or other devices, especially portable products such as flashlights and the like.

The electrical generator depicted in FIGS. 1-3 generates voltage and current as the disc-shaped roller 16 rolls back and forth through the magnetic fluxes provided by magnets 12 flanking the interior of the passageway. Magnets 12 in this embodiment preferably have opposite magnetic poles on their opposite faces, arranged in a sequence of north, south, north, south, starting from the nearest to the farthest face of each pair of flanking magnets. As a result, the axes of the flux lines of each pair of magnets extend transversely through the interior of the passageway. The coils 20 of the roller 16 are, therefore, oriented parallel to the length of the passageway in order to intersect the flux lines perpendicularly and thereby generate maximum voltage and current in the coils and at the output terminals 22.

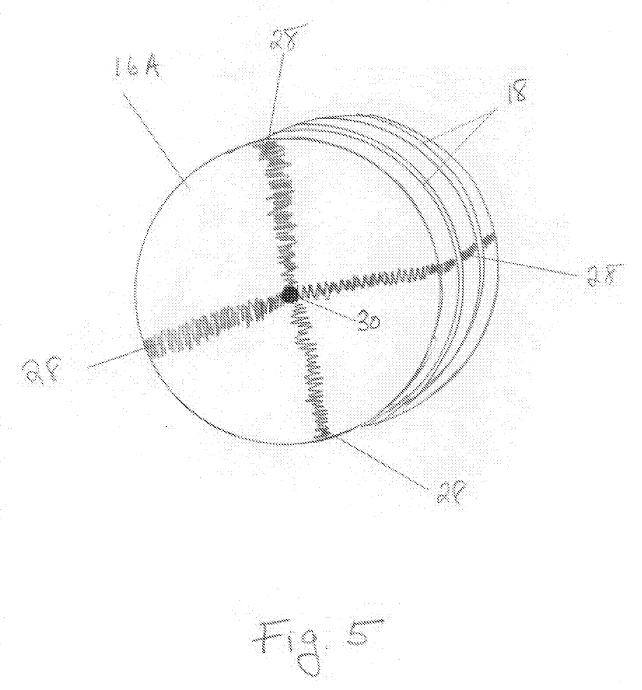

Since the roller 16 is the moving component and the magnets are stationary, the generator of FIGS. 1-3 can be magnetically shielded, as illustrated in the cross sectional view of FIG. 4. The shield comprises magnet 12 sandwiched between the rectangular passageway and a magnetically permeable frame 24 which surrounds the generator and includes a boss 26 abutting the opposite sidewall of the passageway in alignment with the position of magnet 12. Therefore, the magnetic flux is focused and confined within the frame 24, with little or no leakage beyond it.

Referring to FIG. 5, it is an enlarged perspective view of a modified roller 16A which, again, is preferably made of disc-shaped non-conductive material. Instead of wire coils wound around the circular edge of roller 16A, as in FIGS. 1-4, there are sawtooth-shaped bands of conductive wire 28 which extend radially outward from a central hub 30 to and across the circular edge of roller 16A and then down across the opposite face of the roller. The bands 28 are contacted electrically by rings 18, as in FIGS. 1-4. The four bands 28 are separated by the intervening empty sections of the roller 16A.

Thus, as roller 11A enters the flux lines of a permanent magnetic field, as provided by magnets 12, the bands 28 will alternatively intersect the flux lines and then rotate to a position where there is little or no intersection due to the empty spaces between the successive bands. In this way, this embodiment will generate automatic successive pulses of voltage and current as the roller 16A rolls through the passageway. The number and spacing of such bands can be varied and controlled to enable generation of successive pulses of voltage and current when rolling through a magnetic field due to the fluctuating intersections and non-intersections created by the empty spaces between the bands.

The invention has been illustrated and described in terms of its operating principles and specific embodiments. While the moving wire coil 16A is circular and therefore rolls through the passageway, other shapes can be used and caused to move through the passageway by manual or mechanical shaking and oscillation of the generator. Magnets that are affixed to only one of the passageway's sidewalls can be used. The conductive sawtooth wire bands in FIG. 5 can be replaced by other undulating patterns such as sinusoidal and square waveforms, as described in Ser. No. 11/464,275 entitled OMNIDIRECTIONAL ELECTTRICAL GENERATORS, the disclosure of which is incorporated by reference herein.

Other variations of the specific embodiments and operating principles of the invention will be apparent to those skilled in the art. Therefore, it should be understood that it is intended to cover all variations and modifications of the illustrative embodiments that fall within the scope of the appended claims and all equivalents thereof.

The following is claimed:

1. A moving coil electrical generator which comprises:
at least one hollow passageway of predetermined configuration and length;
at least one permanent magnet supported in a position which extends its magnetic flux through empty space within the passageway;
at least one electrically conductive coil placed within and configured to physically move through the passageway; and
at least one pair of contacts on the coil and the passageway which remain in substantial physical contact and electrical continuity with each other as the coil moves through the passageway,
whereby electrical voltage and current are generated in the coil as it moves through and intersects the magnetic flux within the passageway.

2. A generator according to claim 1 which comprises two separate pairs of contacts on the coil and the passageway, the contacts on the passageway extending substantially over its entire length and the contacts on the coils being shaped as rings which are rollable on the passageway's contacts to form an electrical circuit that transmits the voltage and current generated by motion of the coil through the magnetic flux within the passageway.

3. A generator according to claim 1 wherein the contacts on the passageway are connected to output terminals from which the voltage and current generated in the circuit can be accessed by external electrically or electronically operated devices.

4. A generator according to claim 3 wherein the output terminals are connected to portable electronic devices comprising cell phones, i-Pods or MP-3 players.

5. A generator according to claim 4 contained within the housing of a cell phone, i-Pod or MP-3 player and electrically connected to the operating circuits of such devices or to their storage means such as rechargeable batteries or capacitors.

6. A generator according to claim 1 further comprising at least one coil of spiral wound electrically conductive wire supported on a disc-shaped carrier.

7. A generator according to claim 6 wherein the coil comprises insulated electrically conductive wire, the insulation being interrupted in two ring sections of the coil and surrounded with corresponding ring contacts, whereby the voltage and current in the coil is transmitted through the ring contacts to the contacts on the passageway.

8. A generator according to claim 1 further comprising at least one coil of electrically conductive wire wound around a disc-shaped carrier, the windings of the coil being oriented on the carrier to establish substantially perpendicular intersection of the windings with the magnetic flux within the passageway.

9. A generator according to claim 1 further comprising at least one coil of electrically conductive wire supported on a disc-shaped carrier, said coil being formed with sections extending radially from one side, across and over the edge to the other side of the carrier, there being intervening spaces between such radial sections having no coil, whereby intersection of the magnetic flux within the passageway by such radial coil sections generates automatic successive pulses of voltage and current therein.

10. A generator according to claim 1 which is covered with metallic shielding to prevent or minimize magnetic leakage outwardly from the generator.
